(19) United States
(12) Patent Application Publication
(10) Pub. No.: US 2002/0006287 A1
(43) Pub. Date: Jan. 17, 2002

(54) Process for compensation of dimension changes on sheet material

(76) Inventors: Dieter Karl-Heinz Dobberstein, Melsdorf (DE); Joachim Heinrich Haupt, Eschborn (DE); Karlheinz Walter Peter, Molfsee (DE); Jurgen Sahlmann, Ellerdorf (DE); Gerhard Rudolf Sing, Kiel (DE); Rolf Johannes Spilz, Gettorf (DE); Hans-Gunter Werner Staack, Kiel (DE)

Correspondence Address: Lawrence P. Kessler, Patent Department, NexPress Solutions LLC, 1447 St. Paul Street, Rochester, NY, 14653-7103, US

(21) Appl. No.: 09/850,651

(22) Filed: May 7, 2001

(30) Foreign Application Priority Data
May 17, 2000 (DE) 100 23 918.8

(51) Int. Cl. G03G 15/00

(52) U.S. Cl. 399/45; 399/389; 399/401; 399/388

(57) ABSTRACT

The invention relates to a process for compensation of dimension changes on sheet material (1) which is first provided with a printed image (36) on the front (35) and which is then provided with a printed image (40) on its back (39). The dimensions (41, 42) of the sheet material (1) are determined before an image is printed on the front (35) and before an image is printed on the back (39), and before an image is printed on the back (39) of the sheet material (1) the latter is centered to its position when the image was printed on the front (35).

The invention relates to a process for compensation of dimension changes on sheet material, especially those changes of dimensions on sheet material which is printed on both sides.

DE 44 16 564 A1 relates to a sheet alignment device. This device for alignment of a sheet moving along an essentially flat transport path enables alignment of a moving sheet in a plurality of orthogonal directions, for example transversely to the transport path, in the direction of the transport path, and to eliminate skewed positions. The device has a first roller arrangement with a first pressure roller which is supported such that it can turn around one axis which lies in a plane which extends parallel to the plane of the transport path and runs essentially at a right angle to the direction of sheet transport along the transport path. A second roller arrangement has a second pressure roller which is supported such that it can turn around one axis which lies in a plane which extends parallel to the plane of the transport path and runs essentially at a right angle to the direction of sheet transport along the transport path. There is a third roller arrangement which has a third pressure roller which is supported such that it can turn around one axis which lies in a plane which extends parallel to the plane of the transport path and runs essentially at a right angle to the direction of sheet transport along the transport path. The third roller arrangement which can turn around one axis which lies in a plane which extends parallel to the plane of the transport path and runs essentially at a right angle to the direction of sheet transport along the transport path can be moved along its axis of rotation in the direction which runs transversely to the transport path. Finally, there is a control device which is dynamically connected to the first and the second and the third roller arrangement and selectively controls the rotation of the first and second roller arrangement in order to align the front edge of a sheet moving in the direction of sheet transport along the transport path in the position which is at a right angle to the direction of sheet transport. The control means furthermore controls the rotation and the transverse motion of the third roller arrangement in order to align the moving sheet in the direction which runs transversely to the direction of sheet transport and in the direction in which the sheet is moving along the transport path.

The sheet alignment device known from DE 44 16 564 A1 enables the required alignment accuracies to be satisfied only to a limited degree. To achieve the required alignment accuracies, extensive modification of the sheet alignment device of the prior art is necessary, which modification does not seem economical.

In sheet-processing printing presses which work using the offset principle the sheets are conveyed on the feed table in an ragged arrangement before they are aligned on the side and pull-type lay marks which are provided in the plane of the feed table. After completed alignment of the sheet material it is transferred in the aligned state to a pre-gripper which accelerates the sheet material to the machine speed and transfers it to the sheet-guiding cylinder downstream of the pre-gripper means. Other alignment concepts generally use cylindrical rollers with a rubber coating which is held on their core. If with this configuration alignment of sheet material is carried out during its feed by changing the speed between the left and right roller which grip the sheet material, the sheet material undergoes rotation around a pivot which is located on the stationary roller or during feed is located outside the roller with lower rpm or between the two rollers.

In images which are applied or printed using the electro-photography principle to the surface of printed material, the latter is heated after application of the toner to roughly 150° C., so much water being removed from the printed material that depending on the sheet thickness and the fiber position of the printed material, for example of paper fibers, it can shrink to different degrees.

For the lengthwise and transverse extension of the printed material, in the conveyor plane of the latter various shrinkage factors arise, so that varied shrinkage of the sheet material occurs transversely to the fiber direction and it can differ significantly from the shrinkage of the material in the lengthwise direction. If the shrinkage fault in the sheet alignment in duplex operation, i.e. when the back of the sheet material is printed, is ignored, the fault becomes part of the total of the tolerances which result in different positions of the front and back in sheet material which is printed on both sides; this contributes especially to loss of quality in translucent types of printed material.

In view of the approach known from the prior art and the indicated technical problem of sheet shrinkage in printing of printed material on both sides the object of the invention is to compensate as much as possible for the changes in the dimensions of the sheet material which occurs in repeated printing of already printed printing material.

This object is achieved as claimed in the invention by the features of claim 1.

The advantages which can be achieved with the approach as claimed in the invention can be seen mainly in that by means of the alignment process proposed as claimed in the invention when printing the back of sheet material which has already been printed on the front, shrinkage faults caused by a drying unit, for example, a fuser, are taken into account. By determining the absolute changes in the dimension of the sheet material in its lengthwise and transverse extension which can be different from one another, the area of the sheet material which has been modified by shrinkage faults, i.e. the shrunken surface, as it passes through the machine which processes the sheet material, can be taken into account when the now shrunken sheet material is aligned, by which the printed image which is to be applied to the back of the sheet material can be matched as much as possible to the position of the printed image already located on the front of the sheet material.

By means of the process proposed as claimed in the invention, the absolute changes in the dimensions of the sheet material as it passes a fixing unit, for example, a fuser, can be determined before printing the image on the back of the sheet material. Determination of the absolute changes in the dimensions of the sheet material for printing images on its back makes it possible to take into account the different shrinkage values which arise in the sheet material, depending on the direction in which the fibers run, in the lengthwise extension or in the transverse extension of the sheet material, in the alignment of the sheet material which has been made smaller by the shrinkage faults, with a reduced area.

In one version of the process proposed as claimed in the invention, the absolute changes in dimensions can be determined in the lengthwise extension and transverse extension of the sheet material, by which the positional tolerances of the printed image on the back of the sheet material, compared to the position of the printed image applied to the front of the sheet material, are minimized. With the process proposed as claimed in the invention, correction values for the position of the printed image on the back of the sheet material can be determined from averaging of the absolute changes in the dimensions of the sheet material, i.e. from the area of the sheet material corrected by the shrinkage faults.

Here the corrected position of the printed image on the back of the sheet material can be advantageously matched to the area of the sheet material modified by the absolute changes in the dimensions. Thus the position of the printed image applied to the back of the sheet material is essentially congruent to the surface on which the image is printed and which is located on the front of the sheet material, so that the images are printed on top of one another essentially congruently to one another for translucent print material.

By aligning the sheet material before the second pass through the printing unit which processes the sheet material, the edge areas of the unprinted area which surrounds the print image on the back in width and lengthwise extension can also be matched to the now altered, shrunken area of the print material, i.e. shorter in its length and narrower in its width. Before images are printed on the back of the sheet material, it is centered in its planar extension, which is now reduced compared to the first pass through the sheet-processing machine, to the position which the sheet material occupied during the first passage through the sheet processing machine. In this aligned position images have been applied to the front of the printed material, conversely with the process proposed as claimed in the invention the shrinkage faults of the sheet material can be taken into account before application of the printed image to the back of the sheet material. The tolerances of the positions of the printed image on the front of the sheet material to the position of the printed image on the back of the sheet material can thus be minimized.

The invention is detailed below using the drawings.

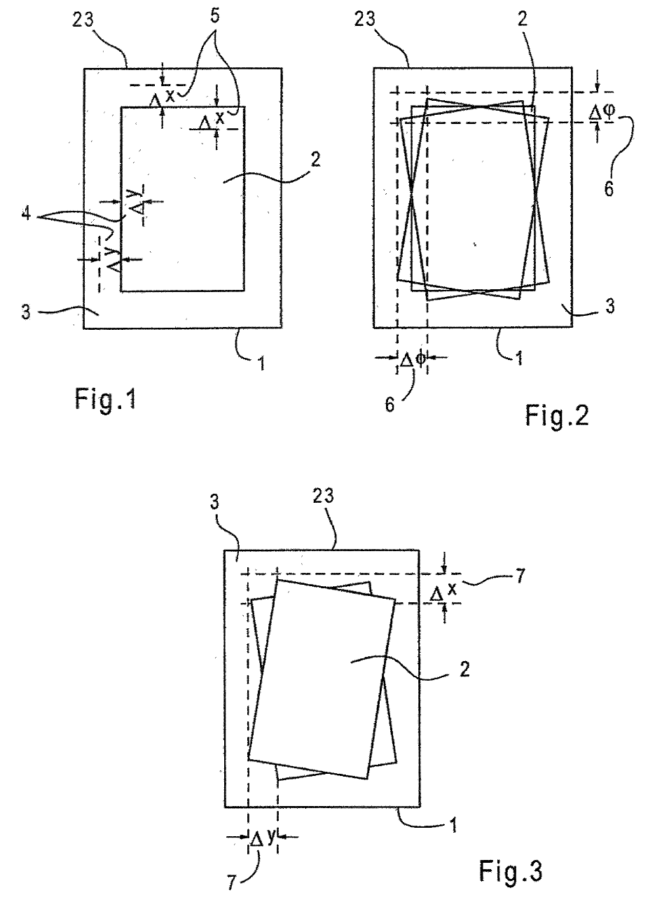

FIG. 1 shows the developing positional deviation of a printed image relative to the surface of the print material accepting it,

FIG. 2 shows the offset of the printed image on the sheet material, i.e. the offset characterized by rotational offset,

FIG. 3 shows an offset of the image which has been printed on the bottom and top of sheet material in perfecting,

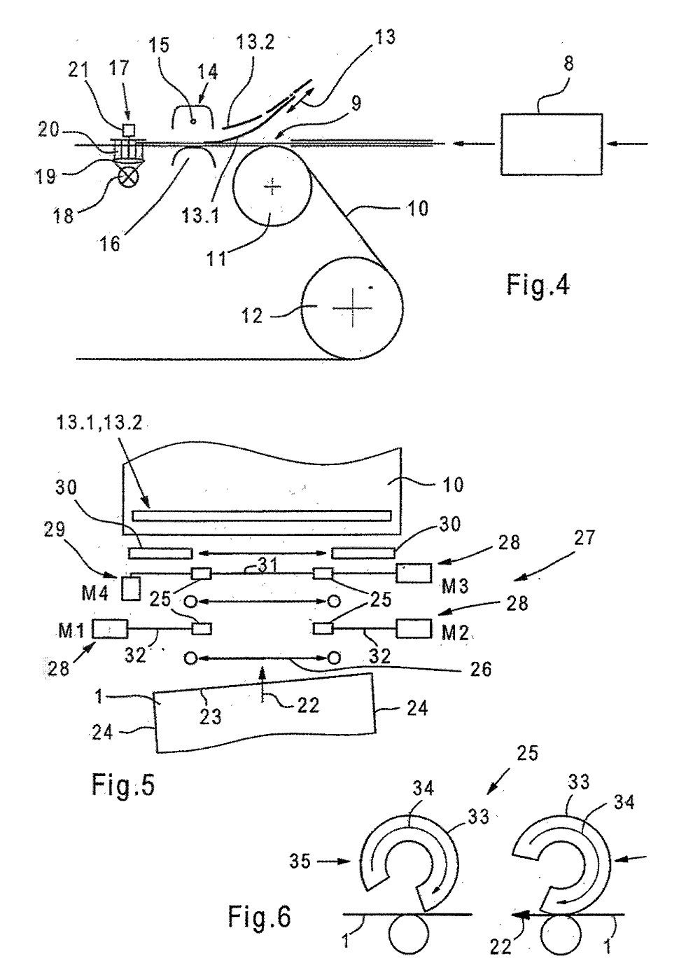

FIG. 4 shows schematically a side view of the sheet feed area of a sheet processing machine,

FIG. 5 shows a plan view of the alignment components, sensor technology and drives for the sheet material relative to the rotation elements which align the direction in which the sheets run,

FIG. 6 shows the rotation elements which are made as segmented rollers above the conveyor plane of the sheet material,

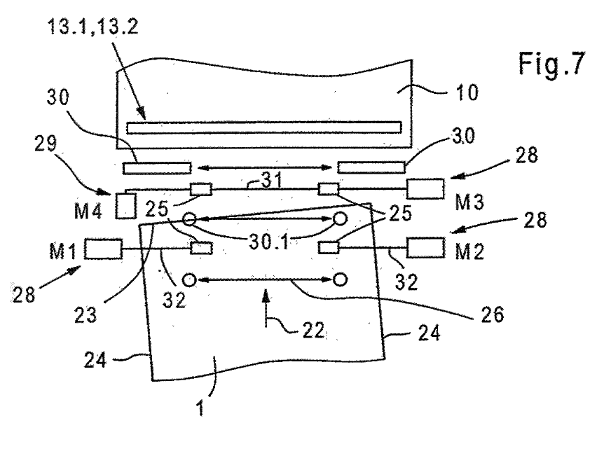

FIG. 7 shows the alignment of sheet material with the drives of the segmented rollers which carry out alignment, and

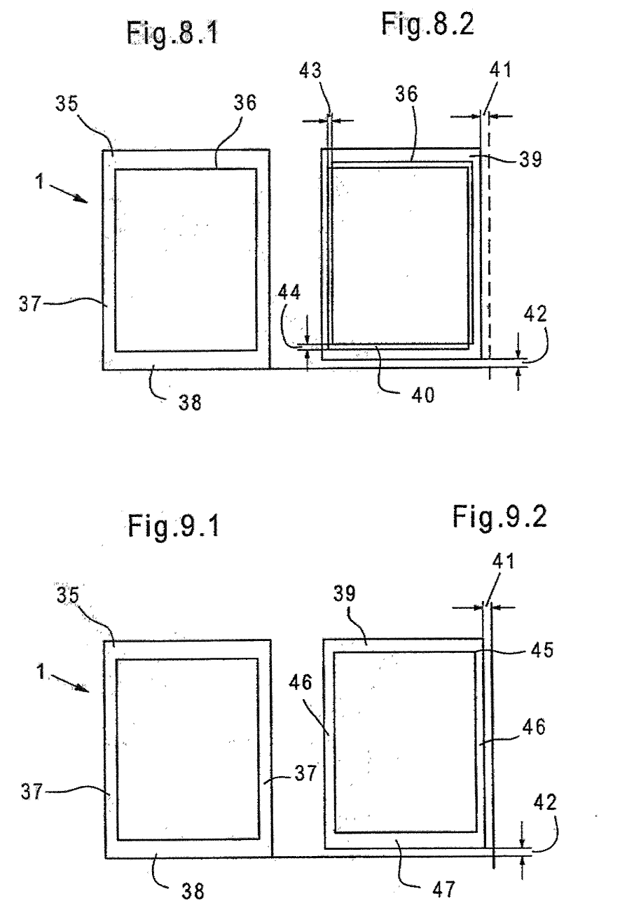

FIGS. 8.1 and 8.2 show the offset of the printed image position on the back, i.e. the offset which develops compared to the printed image on the front, without considering shrinkage effects and

FIGS. 9.1 and 9.2 show the position of the printed image on the back of sheet material, i.e. the position corrected with consideration of shrinkage effects.

FIG. 1 shows sheet material, for example a printed sheet 1, which is oriented at a right angle to its feed direction. The printed sheet 1 contains on its surface a printed image 2 which is surrounded by a frame-like edge 3. The deviations of Dx and Dy which are marked within the printed surface 2 and the frame 3, designating the positioning errors in the x and y direction, can be adjusted when printing the image 2 onto the surface of the sheet material 1. The deviations labeled with reference numbers 4 and 5 are positional deviations, conversely in the representation as shown in FIG. 2 angle deviations of the printed image 2 are shown with reference to its position on the printed sheet 1.

In FIG. 2 the developing angular errors DF are labeled with reference numbers 6. The printed image 2 can be printed in the indicated positions onto the surface of the sheet material 1, this material being conveyed in the conveyor direction with its front edge 23 forward.

FIG. 3 shows in a schematic view the turning register, and the offsets which develop between the printed images 2 on the front and back of the sheet material 1 can be characterized with reference number 7. These offsets are labeled with reference number 7 or Dx and Dy in FIG. 3. The turning register plays a part especially in translucent types of paper and when printing booklets.

FIG. 4 shows in a schematic side view the interface of sheet alignment and feed onto a transport belt.

An alignment unit 8 is connected upstream of a transport belt 10 which runs around a feed roller 11 or a control roller 12; on the surface of the belt the sheet material 1 is held in the conveyor plane. After passing the alignment unit 8 which will be described in greater detail below, the aligned sheet material 1 on the surface of the transport belt 10 travels to the conveyor plane 9. After passing the feed roller 1 the sheet material 1 is captured by an adjustment flap or adjustment lip which can be moved in the adjustment direction 13. The adjustment lip or adjustment flap can be a plastic component which can be moved from the adjusted position 13.1 in the stopped position 13.2; this is shown here only schematically in solid or broken lines. The adjustment flap or adjustment lip presses the sheet material 1 onto the surface of the transport belt 10 in the aligned state of the sheet material 1. After passing the pressure element 13 the sheet material 1 which is held on the surface of the transport belt 10 passes a charging unit 14. In this charging unit 14, inside a hood-shaped cover there is an electrode 15 which provides for static charging of the sheet material 1 and thus for its adhesion to the surface of the transport belt 10.

A front edge sensor 17 follows the charging unit 14 which is shown only schematically in FIG. 4. This sensor consists of a radiation source 18 which is located underneath the conveyor plane 9 and to which a lens arrangement 19 is series connected. The radiation field 20 proceeding from the lens arrangement 19 penetrates the sheet conveyor plane 9 and is incident on a diaphragm arrangement which is located above the conveyor plane 9 of the sheet material 1. The diaphragm arrangement precedes a receiver 21 which senses the presence of the front edge 23 of the sheet material 1.

FIG. 5 shows in a plan view the alignment unit 8 with its components which are shown schematically here. The alignment unit 8 is reached by the sheet material 1 which is conveyed in the conveyor direction 22. The front edge 23 of the sheet material 1 is offset with respect to the direction in which the sheet material 1 is running, by which also the side edges 24 of the sheet material 1 begin to run skewed. As soon as the front edge 23 of the sheet which is in the skewed position with respect to the conveyor direction 22 runs over a first photoelectric barrier 26, the drives 27, labeled M 1 and M 2, which drive rotation elements 25 via individual axes 32, are accelerated to the feed rate. Triggering of the drive 27 or M 1 or M 2 which is initiated via the photoelectric barrier 26 ensures that each copy of the sheet material 1 comes into contact with identical peripheral segments of the rotation elements 25 which can be made for example as segmented rollers. Any developing differences in the feed motion which could be attributed to the dimensional and shape tolerances of the two rotation elements 25 thus occur in the same way for each copy of the sheet material 1 and can be easily calibrated out. After the two rotation elements 25 are set into rotation by passing the first photoelectric barrier 26, the sheet material is transported with the feed rate over another sensor unit 30.1 which follows the first photoelectric barrier 26. As soon as the first of the two sensors of the sensor pair 30.1 has detected the front edge 23 of the sheet material 1, a counter unit begins to count the motor steps. The counting process is then ended and the difference is ascertained when the second sensor of the sensor pair 30.1 operates.

The counter state which has been determined in this way allows determination of a correction value which is relayed as additional feed to the segmented roller drive which was started last, i.e. either the drive 27 which is labeled M 1, or the drive 27 which is labeled M 2. In this way the corresponding body of revolution 25 which is made as a segmented roller is moved with an increased feed rate until the stipulated path difference is completely equalized. At the end of this correction process the front edge 23 is oriented exactly perpendicularly to the direction 21 in which the sheet is running.

After completed correction the sheet material 1 in the conveyor direction 22 is continuously transferred from the first pair of segmented rollers 25 to the other pair of bodies 25 of revolution which follow them and which can be accommodated on a common axis 31. At this point the segmented roller pair 25 which is driven via the drive 27 or M 1 and M 2 is turned off and moves into a neutral position.

The sheet material 1 which is now correctly aligned with respect to its angular position now runs onto a sensor array 30 in which the position of the side edges 24 of the sheet material 1 is measured. The change in position for the drive 27 which is labeled M4 and which has a drive shaft which extends parallel to the conveyor direction 22 is determined from the established measured value. By means of this drive 27 which is held in a second orientation 29 the position of the sheet material 1 parallel to the direction 22 in which it is running is corrected (compare FIG. 7).

Afterwards the sheet 1 which is aligned in its angular position and its lateral position runs underneath an adjustment flap or adjustment lip element 13 which has been placed in a position 13.1 or 13.2 onto the transport belt 10 in order to run into the downstream printing unit in the correctly aligned position. FIG. 6 shows one embodiment of the rotation elements 25 which are located above the conveyor plane held in the alignment unit 8. The rotation elements 25 in one preferred embodiment can be made as segmented rollers which have a peripheral surface 33 which is characterized by an interruption. The segmented rollers 25 rotate in direction 34 which is characterized by the illustrated arrow and describe roughly a ¾ circle with reference to their axis of rotation. Underneath the respective segmented roller 25 the roller 34 which supports the sheet material 1 is shown.

The bodies of revolution which are used as the segmented rollers 25 are shown in the neutral position in the left-hand part of FIG. 6, while in the right-hand part of FIG. 6 they grip one copy of the sheet material 1 conveyed in the running direction 22 by its peripheral surface 33 and transport it according to the direction of rotation 34 in the direction 22 in which the sheet is running. FIG. 7 shows the correction of the angular position of the sheet material 1 as it passes the alignment unit 8. In the position of the sheet material 1 shown in FIG. 7 its front edge 23 has just reached the last sensor of the sensor pair 30.1 so that now the drive 27 of the segmented roller 25, which drive is labeled M 1, can be activated to equalize the angular position of the sheet material 1 with reference to the direction 22 in which it is running. It should be mentioned that in contrast to drives M 3 and M 4 which are joined to one another via a continuous drive shaft 31 the segmented rollers 25 which are connected to the drives M 1 and M 2 are each driven via individual shafts 32. After correction of the angular position of the sheet material 1 by activations of the respective drives 27 (M 1 and M 2) of the segmented rollers 25 at different speeds, the sheet material 1 undergoes correction of its side position. After measurement of the position of the side edges 30 of the sheet material 1 by the sensors 31 the sheet material 1 is now correctly aligned now parallel to the conveyor direction 22 by the displacement of the sheet material 1 taking place via the drive M 4 in its conveyor plane before reaching the adjustment element 13 and before running onto the transport belt 10. With drive M 3 oriented in the first orientation 28, via a common shaft 31 the feed of the sheet material 1 with the front edge 23 correctly aligned is ensured, while it is aligned in its lateral position via the drive 27, labeled M 4, which is held in the second orientation 29.

FIGS. 8.1 and 8.2 show printing of an image on sheet material 1 on the front and back with the printed image offset which develops on the back.

FIG. 8.1 shows the front 35 of the sheet material 1. A printed image is applied to the front 35 of the sheet material 1 and is spaced on its edges with edges spacing 37 in the x-direction and with an edge spacing 38 in the y-direction away from the edges of the sheet material 1.

FIG. 8.2 shows the sheet material 1 which is shown in FIG. 8.1 viewed from its back.

On the front 35 is the printed image 36, on the back 39 of the sheet material 1 shown in FIG. 8.2 is the printed image 40 applied offset to the surface to the sheet material. The surface extension of the sheet material 1 in the plane of the drawing has been reduced in FIG. 8.2 by the absolute shrinkage 42 and 41 in the transverse extension of the sheet material 1. The offset with which the printed image 40 is applied to the back 39 of the sheet material 1 is labeled with reference numbers 43 and 44. For a translucent print material, for example in very thin print material with low paper weight the offset of the printed images 36 and 40 which is shown in FIG. 8.2 reduces quality on the front 35 and the back 39 of the sheet material 1.

FIG. 9.1 corresponds essentially to the representation of the front 35 of the sheet material 1 as shown in the already described FIG. 8.1.

FIG. 9.2 shows the back 39 of the sheet material 1 onto which an image 40 is printed in the corrected position 45. The flat sheet material 1 as shown in FIG. 9.2 in its absolute dimension in the lengthwise direction is shrunk by an amount 42 and in the transverse direction by an amount 41. The shrinkages in the lengthwise and transverse direction can differ entirely from one another depending on the fiber direction, when the sheet material 1 is paper. Before printing the back 38 the material 1 which has shrunk by the absolute amounts 41 and 42 in the transverse direction and the lengthwise direction respectively is re-aligned before it is printed on its back 39. The shrinkage faults are detected during alignment and then determined before the back 39 of the sheet material 1 to be printed is supplied again to the machine which processes the sheet material 1. Before the sheet material 1 passes through the sheet-processing machine again, the now shrunken sheet material 1 is roughly centered to the position which the sheet material had assumed before printing its front 35 in the sheet machine [sic] in the machine which process the sheet material 1. In this way, with reference to the corrected position of the printed image 45, on its edges narrower edge areas 46 and 47 develop. The edge areas on the one hand take into account the corrected position of the printed image 45 on the back 39 of the sheet material 1 and are thus necessarily matched to the new dimensions in the lengthwise extension and transverse extension of the shrunken sheet material.

1. Process for compensation of dimension changes on sheet material (1) which is first provided with a printed image (36) on the front (35) and which is then provided with a printed image (40) on its back (39), wherein the dimension changes (41, 42) of the sheet material (1) are determined before an image is printed on its front (35) and before an image is printed on its back (39), and before printing on the back (39) the sheet material (1) is centered to its position when the image was printed on the front (35).

2. Process as claimed in claim 1, wherein the absolute dimension changes (41, 42) of the sheet material (1) are determined before printing an image on the back (3) of the sheet material (1).

3. Process as claimed in claim 1, wherein the absolute dimension changes (41, 42) in the lengthwise extension and in the transverse extension of the sheet material (1) are averaged.

4. Process as claimed in claim 3, wherein correction values (43, 44) for the position (45) of the printed image (40) on the back (39) of the sheet material (1) are determined from averaging of the absolute dimension changes (41, 42) on the sheet material (1).

5. Process as claimed in claim 3, wherein the corrected position (45) of the printed image (40) on the back (39) of the sheet material (1) is matched to the area of the sheet material (1) which has been modified by the absolute dimension changes (41, 42).

6. Process as claimed in claim 3, wherein the edge areas (46, 47) which are formed for the corrected position (45) of the printed image (40) on the back (39) of the sheet material (1) are matched to the resulting area of the sheet material (1).

7. Process as claimed in claim 1, wherein before printing an image on the back (39) of the sheet material (1) the latter is centered with the area which has been corrected by the absolute dimension changes (41, 42) to its position when the image was printed on the front (35).
